(19) United States
(12) Patent Application Publication
(10) Pub. No.: US 2011/0049048 A1
(43) Pub. Date: Mar. 3, 2011

(54) WATER PURIFICATION SYSTEM

(75) Inventors: William Benner, Flower Mound, TX (US); Jeffrey Scott Sanem, Brooklyn Park, MN (US); Robert Banks, Chaska, MN (US); Kristy Marie Dunchak, Minnetonka, MN (US); Hitomi Nishida, Plymouth, MN (US)

(73) Assignee: General Electric Company, Schenectady, NY (US)

(21) Appl. No.: 12/855,939

(22) Filed: Aug. 13, 2010

Related U.S. Application Data
(60) Provisional application No. 61/239,596, filed on Sep. 3, 2009.
(60) Provisional application No. 61/239,611, filed on Sep. 3, 2009.

(51) Int. Cl. C02F 1/44; B01D 63/00; B01D 61/14

(52) U.S. Cl. 210/636; 210/257.2; 210/182; 210/195.2

(57) ABSTRACT

The present invention concerns a water purification system comprising an ultrafiltration unit, a reverse osmosis unit, and a tank. The ultrafiltration unit is upstream of the tank on an operation conduit and the tank is upstream of the reverse osmosis unit on a reverse osmosis conduit. A backwash conduit is situation between said tank and said ultrafiltration unit.

### CROSS-REFERENCE TO RELATED APPLICATIONS

This application is entitled to the benefit of Provisional Patent Application Ser. No. 61/239,611 filed Sep. 3, 2009, and titled COMBINATION OF UF AND RO MEMBRANES ON A SINGLE SKID; and Provisional Patent Application Ser. No. 61/239,596 filed Sep. 3, 2009, and titled USE OF SINGLE TANK FOR UF CIP, UF BACKWASH, UF PERMEATE TANK, RO CIP TANK VERSUS THE CONVENTION USE OF FOUR SEPARATE TANKS. Both of the above listed applications are herein incorporated by reference.

### BACKGROUND OF THE INVENTION

1. Field of the Invention

This invention relates to a water purification system. In particular, it relates to a water purification system having a tank.

2. Description of Related Art

Traditionally, ultrafiltration and reverse osmosis water purification systems employ multiple tanks, such as an ultrafiltration clean-in-place tank, an ultrafiltration backwash tank, an ultrafiltration permeate break tank, and a reverse osmosis clean-in-place tank. Accordingly, a need exists to reduce the number of tanks required by a water purification system.

### SUMMARY OF THE INVENTION

The present invention concerns a water purification system comprising an ultrafiltration unit, a reverse osmosis unit, and a tank. The ultrafiltration unit is upstream of the tank on an operation conduit and the tank is upstream of the reverse osmosis unit on a reverse osmosis conduit. A backwash conduit is situation between said tank and said ultrafiltration unit.

### BRIEF DESCRIPTION OF THE DRAWINGS

These and other aspects of the invention will be understood from the description and claims herein, taken together with the drawings showing details of construction and illustrative embodiments, wherein:

FIG. 1 schematically illustrates a water purification system operating in an ultrafiltration/reverse osmosis production mode in accordance with one embodiment of the present invention;

FIG. 2 schematically illustrates a water purification system operating in an ultrafiltration backwash/reverse osmosis production mode in accordance with one embodiment of the present invention;

FIG. 3 schematically illustrates a water purification system operating in an ultrafiltration daily maintenance cleaning mode in accordance with one embodiment of the present invention;

FIG. 4 schematically illustrates a water purification system operating in an ultrafiltration daily maintenance rinsing mode in accordance with one embodiment of the present invention;

FIG. 5 schematically illustrates a water purification system operating in an ultrafiltration monthly recovery clean recirculation and soak mode in accordance with one embodiment of the present invention;

FIG. 6 schematically illustrates a water purification system operating in an ultrafiltration monthly recovery clean rinse mode in accordance with one embodiment of the present invention;

FIG. 7 schematically illustrates a water purification system operating in an reverse osmosis quarterly clean mode in accordance with one embodiment of the present invention; and

FIG. 8 schematically illustrates a water purification system operating in an reverse osmosis quarterly rinse mode in accordance with one embodiment of the present invention.

### DETAILED DESCRIPTION

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges stated herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

As used herein, the terms “comprises”, “comprising”, “includes”, “including”, “has”, “having”, or any other variation thereof, are intended to cover a non-exclusive inclusion. For example, a process, method, article or apparatus that comprises a list of elements is not necessarily limited to only those elements, but may include other elements not expressly listed or inherent to such process, method, article, or apparatus.

The singular forms “a”, “an”, and “the” include plural referents unless the context clearly dictates otherwise.

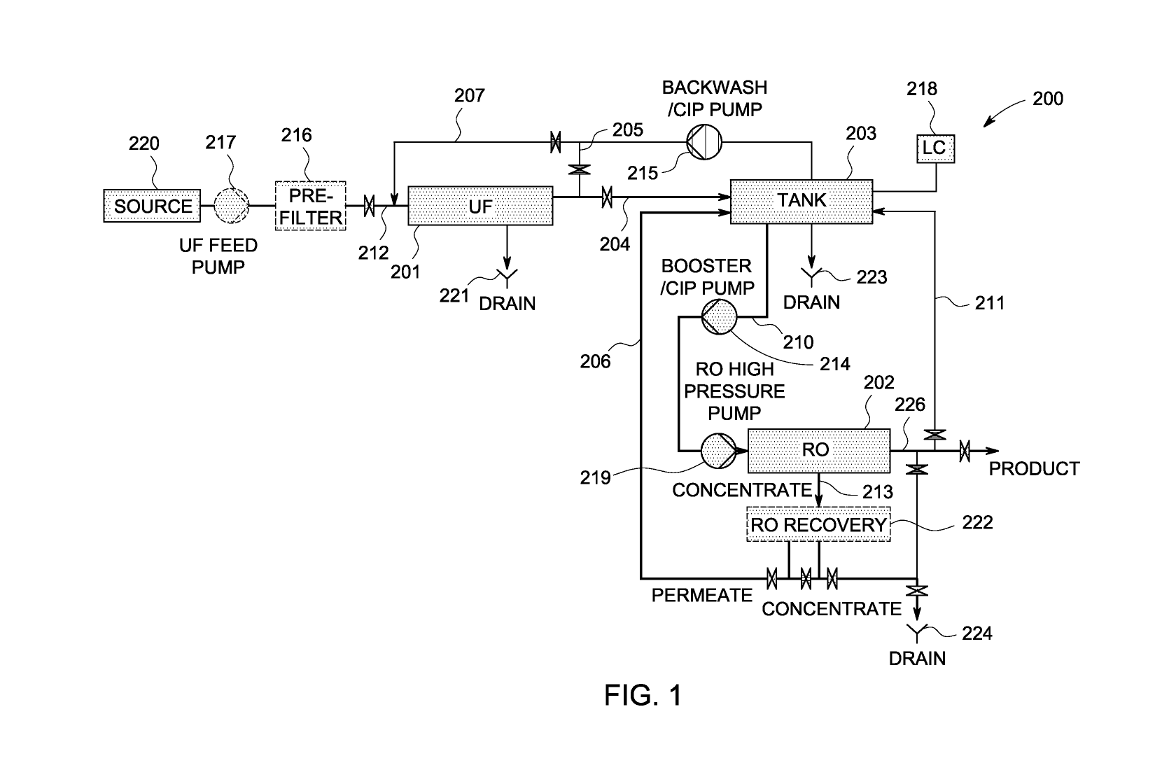

The water purification system 200 depicted in Modes 1-5 of FIGS. 1-8 comprises an ultrafiltration membrane (“UF”) unit 201, a backwash/clean in place (“CIP”) pump 215, a booster/clean in place (“CIP”) pump 214, an Reverse Osmosis (“RO”) high pressure pump 219, an RO unit 202, a tank 203, and a tank level control 218 (“LC”). The UF unit 201 is sized to provide continuous flow through the RO unit 202. Optionally, the system can include a UF feed pump 217, a pre-filter 216, and a RO recovery unit 222. The tank 203 receives inflows from the RO unit 202, the RO recovery unit 222, and the UF unit 201. Further, the tank 203 is multifunctional in that it acts as a UF permeate break tank and as a source for the backwash/CIP pump 215 and booster/CIP pump 214. LC 218 is used in each mode to monitor and control the fluid level in tank 203. In FIGS. 1-8, the conduits that are used in the mode depicted in each drawing are bold, the active components are shaded, and the dormant components are hatched.

As can be seen in FIGS. 1-8, both the UF unit 201 and tank 203 have individual drains 221 and 223. Normally, the contents of the UF unit 201, tank 203, RO unit 202, and RO recovery unit 222 can be drained into gray water drains However, if the contents include acid or other substances that cannot be disposed in the same manner as gray water, the contents are drained into a neutralization tank. Further, it is contemplated that in some embodiments, the RO unit permeate, RO unit concentrate, RO recovery unit permeate, and RO recovery unit concentrate have separate drain lines. It is contemplated that some embodiments of water purification system 200 can process about 100 gpm to about 300 gpm of water. Further, it is contemplated that other embodiments of water purification system 200 can process about 50 gpm to about 500 gpm of water.

Turning to FIG. 1, which depicts Mode 1, UF/RO production mode, the UF feed pump 217 directs source 220 water through the pre-filter 216 and UF unit 201. An operation conduit 204 conducts UF permeate to the tank 203. An RO conduit 210 conducts UF permeate from the tank 203 to the booster/CIP pump 214, RO high pressure pump 219, and RO unit 202. Permeate exits the RO unit 202 as product, and the RO unit concentrate passes into an optional RO recovery unit 222. The RO recovery unit permeate is returned to the tank 203 via RO recovery conduit 206, and the RO recovery unit concentrate is directed into the RO/RO recovery drain 224.

Additionally, the optional RO recovery unit 222 can be bypassed by directing the RO unit concentrate into the RO/RO recovery drain 224. If a system does not contain the optional RO recovery unit 222, the RO unit concentrate is directed into the RO/RO recovery drain 224.

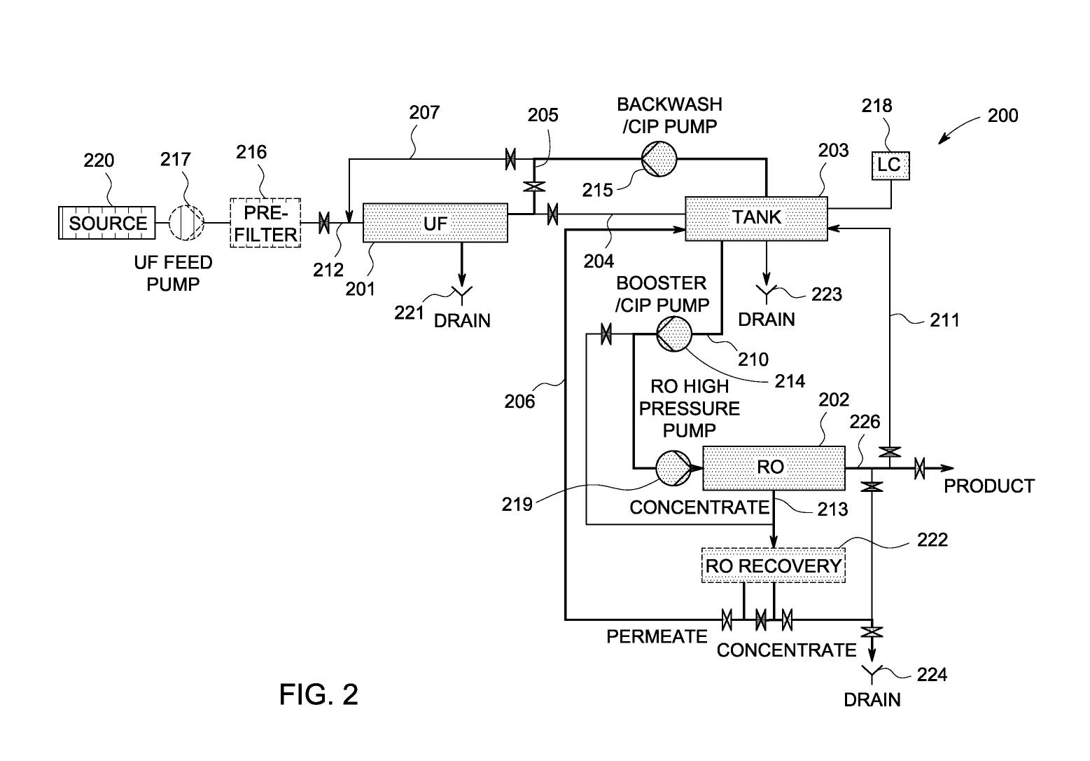

Turning to FIG. 2, which depicts Mode 2, UF unit backwash and RO unit production mode, the system uses the contents of the tank 203 to simultaneously operate in a backwash mode of operation and produce product with the RO unit 202. Accordingly, the tank 203 is sized for continuous RO operation during backwash mode. In backwash mode, the backwash/CIP pump 215 conducts UF permeate from the tank 203, through the backwash conduit 205, and backward through the UF unit 201. The UF permeate then exits the UF unit 201 and is directed to the UF unit drain 221.

Further, in Mode 2, an RO conduit 210 conducts fluid from the tank 203, through the booster/CIP pump 214 and RO high pressure pump 219, and to the RO unit 202. The RO unit permeate exits as product, and the RO unit concentrate passes to the RO recovery unit 222. The RO recovery unit permeate is returned to the tank 203 via the RO recovery conduit 206, and the RO recovery unit concentrate is directed to the RO/RO recovery drain 224. If a system does not contain the optional RO recovery unit 222, the RO unit concentrate is directed to the RO/RO recovery drain 224.

In the preferred embodiment, the system enters Mode 2 approximately every 30 minutes, based on recovery and feed water. The duration of Mode 2 is approximately 120 seconds, including pre-aeration, backwash/CIP pump 215 ramp up and ramp down, UF feed pump 217 ramp up and rinse. Below is a chart detailing one possible Mode 2 backwash process, of which there are alternatives. This chart discusses the use of aeration equipment, such as a UF unit scour blower, which is contemplated to be included in some embodiments.

| | | Duration, | Total elapsed |
|---|---|---|---|
| Process Step | Description | (seconds) | time (seconds) |
| UF Feed pump | UF Feed pump ramp- | 10 | 10 |
| ramp-down | down and valve rotation | | |
| Backwash/CIP | Aeration and ramp-up | 5 | 15 |
| pump ramp-up | Backwash/CIP pump | | |
| Backwash | Aeration and backwash | 60 | 75 |
| Backwash/CIP | Backwash/CIP pump | 10 | 85 |
| pump ramp-down | ramp-down and valve | | |
| | rotation + aeration off | | |
| UF Feed pump | UF Feed pump ramp-up | 5 | 90 |
| ramp-up (feed flush) | for feed flush | | |
| UF Feed flush | UF Feed flush | 30 | 120 |
| Production | Valve rotation for | | |
| | production | | |

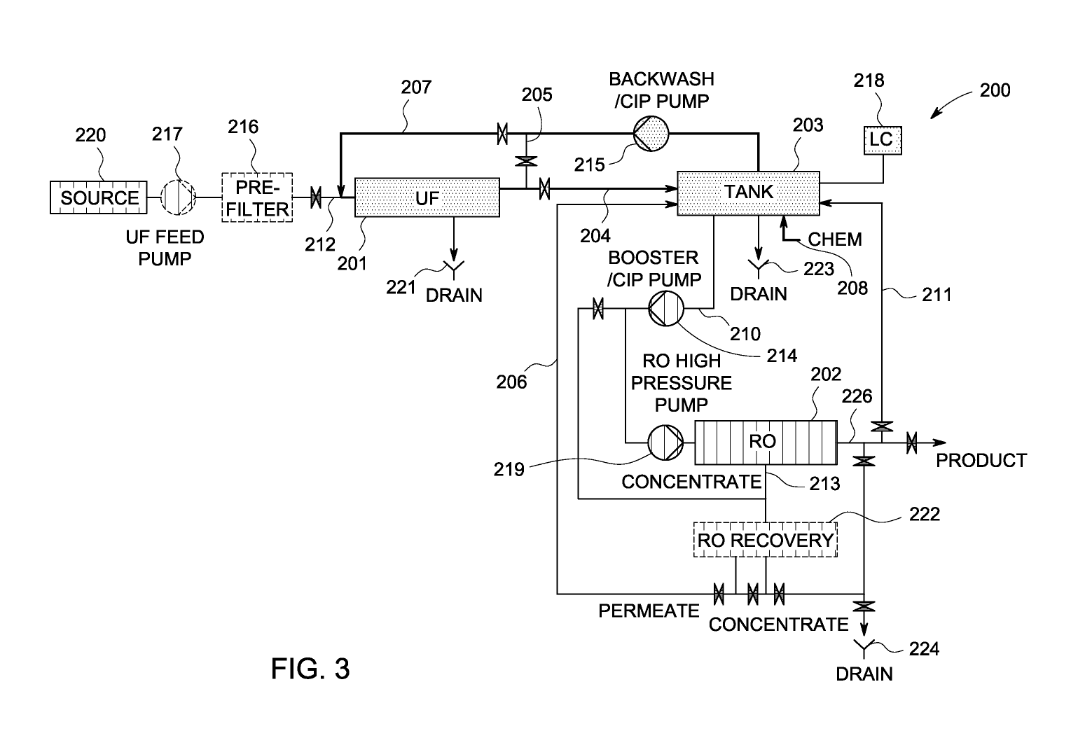

Turning to FIG. 3, which depicts Mode 3a, the system is placed in a UF daily maintenance cleaning mode. In the UF daily maintenance cleaning mode, a cleaning fluid is prepared in the tank 203 by adding chemicals to the contents of the tank 203 through chemical feed line 208. Such chemicals can include citric acid or phosphoric acid to help control inorganic fouling, and hypochlorite to help control organic fouling. The backwash/CIP pump 215 conducts fluid from the tank 203 to the UF cleaning conduit 207, which directs the fluid along an upstream to downstream direction through the UF unit 201, before returning the fluid back to the tank 203. The RO unit 202 is usually shut down during the daily maintenance cleaning mode.

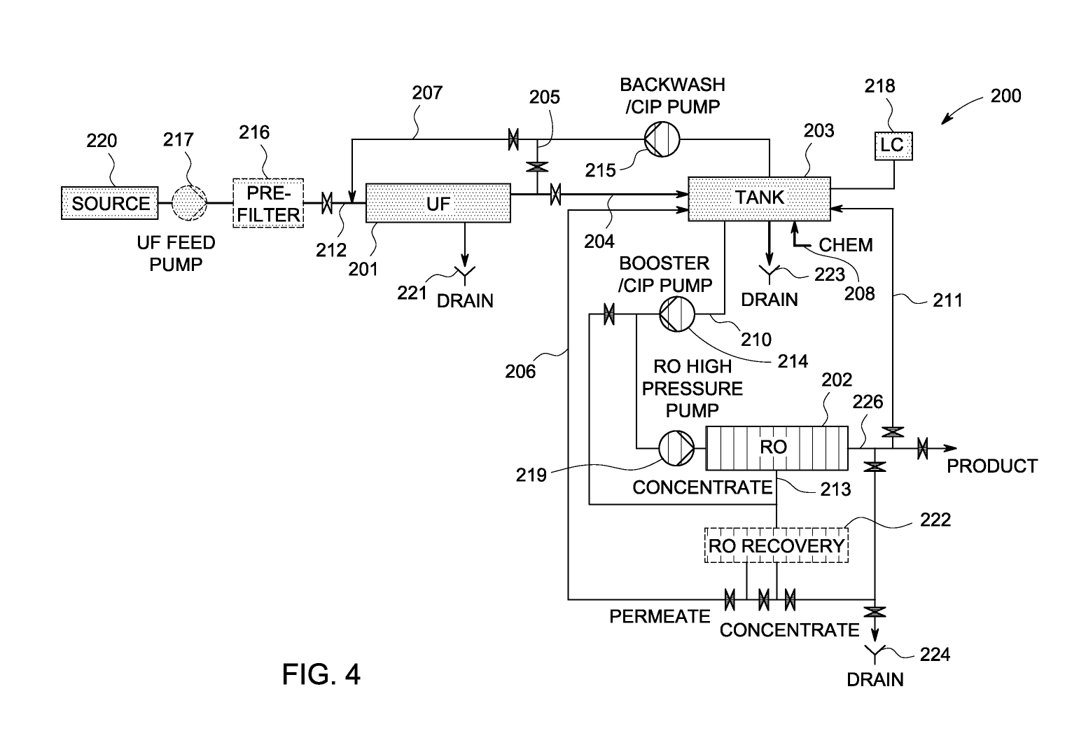

Following Mode 3a, the system is placed in Mode 3b, which is depicted in FIG. 4, a daily maintenance rinse mode. In the daily maintenance rinse mode, the UF feed pump 217 sends source 220 water through a UF rinsing conduit 212, which directs source 220 water from an upstream to downstream direction through the pre-filter 216, the UF unit 201, and into the tank 203. Rinsing fluid used during the daily maintenance rinse mode is drained via UF unit drain 221 and tank drain 223. Additionally, the RO unit 202 is normally shut down during this rinse mode.

The daily maintenance cleaning prolongs the life of the UF membranes. In the preferred embodiment, the duration of Mode 3a-b is approximately 27 minutes, which includes the UF drain, CIP content transfer, recirculation, draining the CIP solution, and chemical flush. Below is a chart detailing one possible Mode 3a-b daily maintenance clean and rinse process, of which there are alternatives.

| | | | Total elapsed |
|---|---|---|---|
| | | Duration, | time |
| Process Step | Description | (minutes) | (minutes) |
| Fill tank with | Tank filled with permeate, | | |
| chemical solution | (optional heating), | | |
| | Chemicals mixed | | |
| Stop System | | 0 | 0 |
| Drain UF Unit | Drain unit using UF feed | 2 | 2 |
| | pump | | |
| Transfer Tank | Pump chemical from | 3 | 5 |
| Contents Using | tank to the UF modules | | |
| Backwash/CIP pump | | | |
| Recirculate | Recirculate CIP solution | 15 | 20 |
| | using Backwash/CIP | | |
| | pump | | |
| Drain CIP Solution | Drain CIP solution to tank | 2 | 22 |
| Chemical Flush | Fill UF unit with feed and | 5 | 27 |
| | direct permeate to | | |
| | neutralization drain | | |
| Start system | | | |

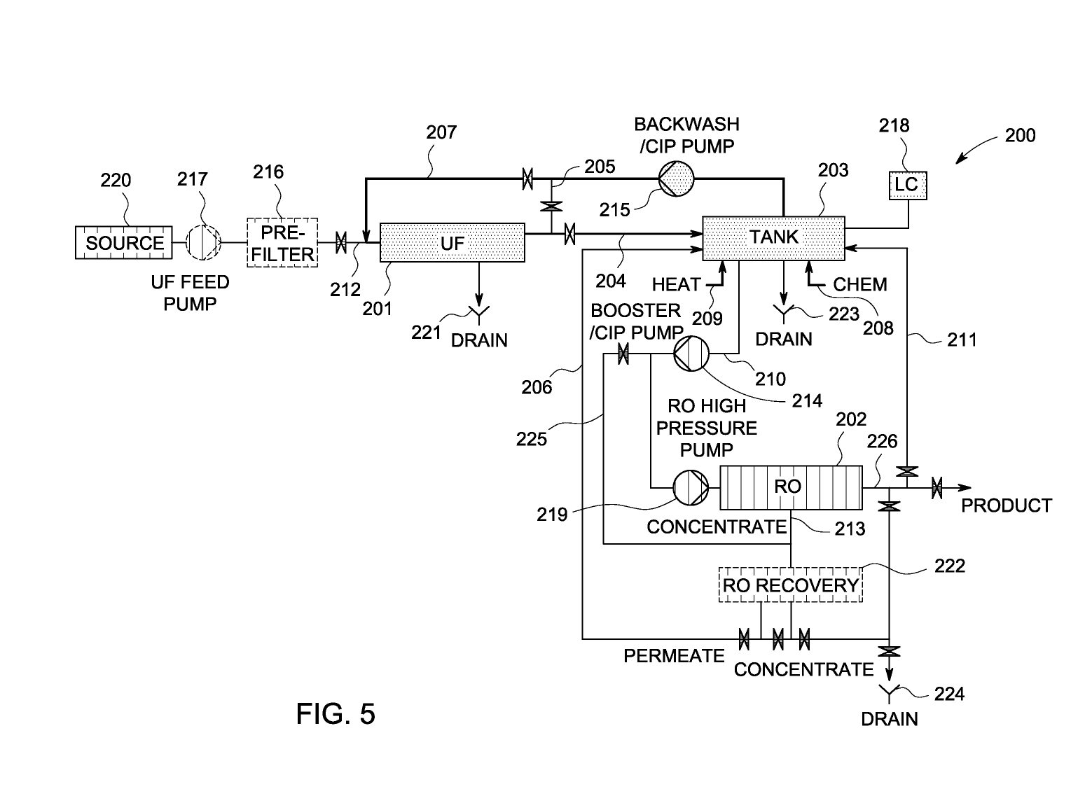

Turing to FIG. 5, which depicts Mode 4a, the system is placed in a UF monthly recovery clean recirculation and soak mode. In this mode, a cleaning fluid is prepared in the tank 203 by adding chemicals to the contents of the tank 203 through chemical feed line 208 and heating the fluid using heater 209. Such chemicals can include sodium hypochlorite to help control organic fouling, and citric acid or phosphoric acid to help control inorganic fouling. The backwash/CIP pump 215 conducts fluid from the tank 203 to the UF cleaning conduit 207, which directs the fluid along an upstream to downstream direction through the UF unit 201, before returning the fluid back to the tank 203. Bisulfite is added at the end of this mode to remove any chlorine. The tank 203 and heater 209 are sized such that the contents of the tank 203 can be heated to 40° C. (104° F.) in four hours. The RO unit 202 is usually shut down during this mode. Mode 4a cleaning is more extensive than Mode 3a.

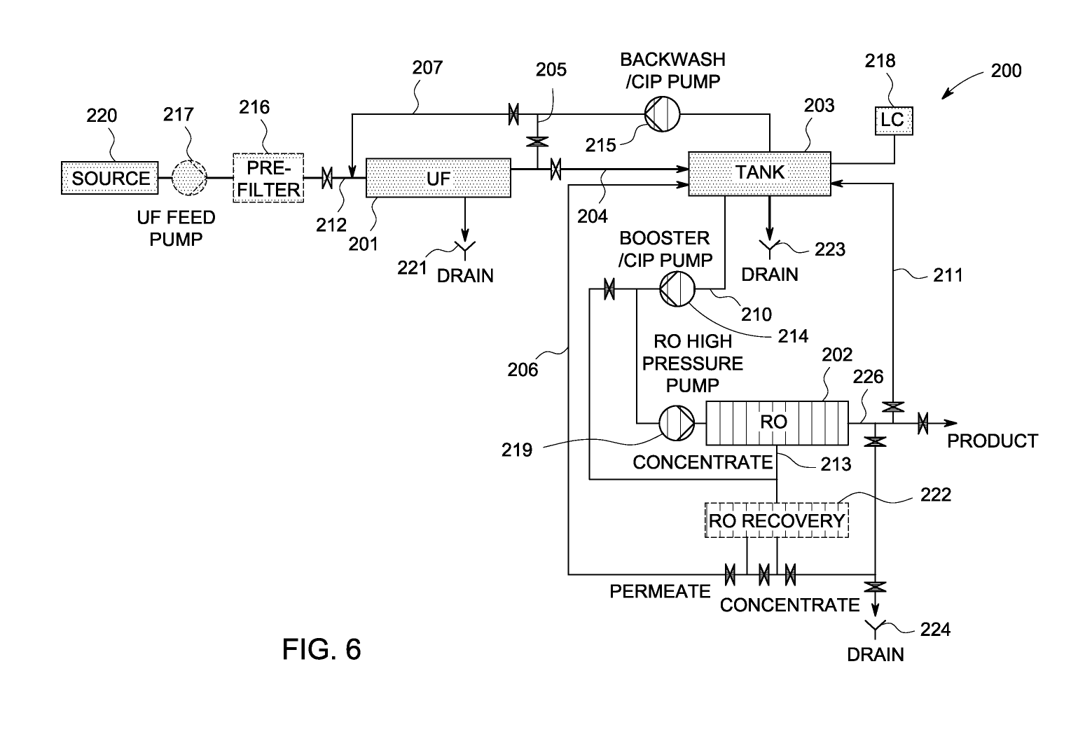

Following Mode 4a, the system is placed in Mode 4b, which is depicted in FIG. 6, a UF monthly recovery clean rinse. In this mode, the UF feed pump 217 sends source 220 water through a UF rinsing conduit 212, which directs source 220 water from an upstream to downstream direction through the pre-filter 216, the UF unit 201, and into the tank 203. The UF unit 201 and tank 203 both include a drain 221 and 223 for draining the rinsing fluid during the UF monthly recovery clean rinse mode. Additionally, the RO unit 202 is normally shut down during this rinse mode.

In the preferred embodiment, the duration of Mode 4a-b is approximately 317 minutes, which includes the UF drain, CIP content transfer, recirculation and soak, draining the CIP solution, and chemical flush. Below is a chart detailing one possible Mode 4a-b monthly recovery clean recirculation, soak, and rinse, of which there are alternatives.

| | | | Total elapsed |
|---|---|---|---|
| | | Duration, | time, |
| Process Step | Description | (minutes) | (minutes) |
| Fill tank with | Tank filled with permeate, | ( ~240) | |
| chemical | heated, Chemicals mixed | | |
| solution | | | |
| Stop system | | 0 | 0 |
| Drain rack | Drain rack using UF feed pump | 2 | 2 |
| Transfer CIP | Pump chemical from tank | 3 | 5 |
| Content | to the UF modules | | |
| Recirculate and | Recirculate tank solution for | 300 | 305 |
| Soak | 5 min and soak for 25 min; | | |
| | repeat this cycle 10 times | | |
| Drain CIP | Drain CIP solution to | 2 | 307 |
| Solution | neutralization drain | | |
| Chemical Flush | Fill rack and rinse to | 5 | 312 |
| | neutralization drain | | |
| Start system | | | |

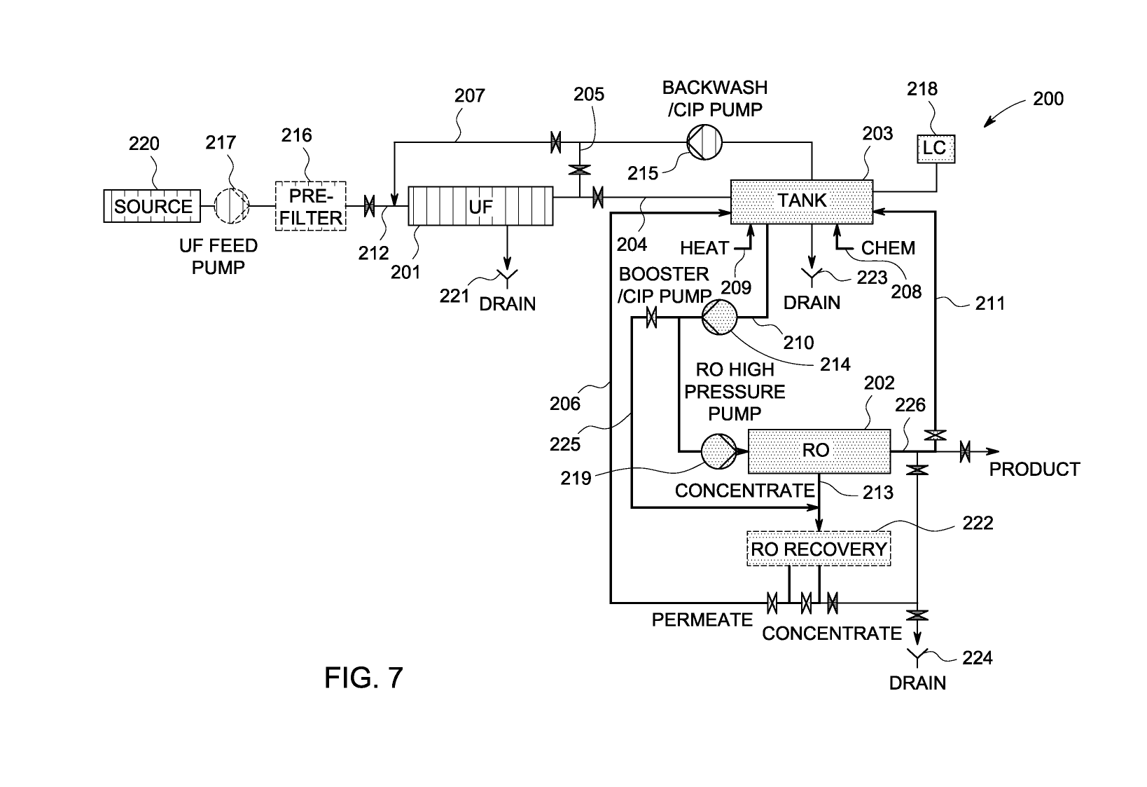

Turning to FIG. 7, in Mode 5a, the system is placed in a RO cleaning mode. Here, the operation, backwash, cleaning, and rinsing conduits are closed. In this mode, a cleaning fluid is prepared in the tank 203 by adding chemicals to the contents of the tank 203 through the chemical feed line 208 and heating the fluid with the tank immersion heater 209. A booster/CIP pump 214 conducts fluid from the tank 203 to the RO conduit 210, which directs the fluid through the RO high pressure pump 219 and into the RO unit 202. The RO unit permeate is returned to the tank 203 through a recycle conduit 211 and the concentrate is directed to the RO recovery unit 222. The permeate and concentrate from the RO recovery unit 222 are both returned to the tank 203 through a RO recovery conduit 206.

Alternatively, in Mode 5a, the RO unit 202 can be bypassed by shutting down the RO high pressure pump 219 and utilizing only the booster/CIP pump 214 to conduct fluid from the tank 203 to the RO recovery unit 222 via the RO recovery bypass conduit 225. The permeate and concentrate from the RO recovery unit 222 are both returned to the tank 203 through a recovery recycle conduit 211.

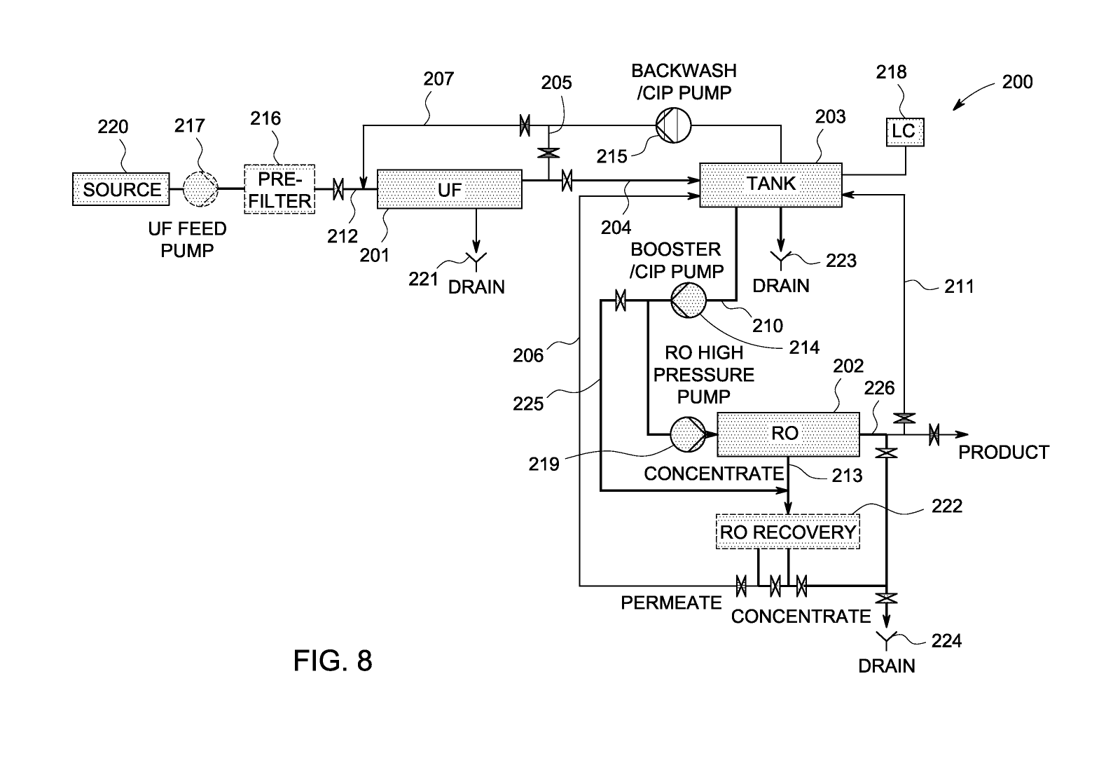

Following Mode 5a, the system is placed in Mode 5b, as depicted in FIG. 8, a RO clean rinse mode. Here, source 220 water is pumped by the UF feed pump 217 through the pre-filter 216 and UF unit 201 along the operation conduit 204 and into the tank 203. A booster/CIP pump 214 conducts UF permeate from the tank 203 to the RO high pressure pump 219, which directs UF permeate along the RO conduit 210 into the RO unit 202. The RO unit permeate is directed to the RO/RO recovery drain 224 and the RO unit concentrate is directed to the RO recovery unit 222. The RO recovery unit permeate and concentrate are directed to the RO/RO recovery drain 224.

Alternatively, in Mode 5b, the RO unit 202 can be bypassed by shutting down the RO high pressure pump 219 and utilizing only the booster/CIP pump 214 to conduct fluid from the tank 203 to the RO recovery unit 222 via the RO recovery bypass conduit 225. The RO recovery unit permeate and concentrate are directed to the RO/RO recovery drain 224. In one embodiment, RO cleaning mode depicted in 5a and 5b are carried out about once a quarter.

Stated alternatively, in a water purification system 200 of the type in which influent water flows along an upstream to downstream direction, through an upstream UF unit 201 and through a downstream RO unit 202, a tank 203 is located intermediate said UF unit 201 and said RO unit 202. An operation conduit 204 is provided to conduct UF permeate to the tank 203. An RO conduit 210 is provided to conduct UF permeate from the tank 203 to the RO unit 202 in a purification operational mode. Additionally, a backwash conduit 205 is provided between the tank 203 and the UF unit 201 for directing a backward or countercurrent fluid flow from the tank 203 in a downstream to upstream direction through the UF unit 201 in a UF backwash mode of operation. During the backwashing mode, permeate feed from the tank 203 through the RO unit 202 via the RO conduit 210 may proceed, if desired.

In a daily maintenance cleaning mode of operation, a UF cleaning conduit 207 is provided between the tank 203 and the UF unit 201 for directing cleaning fluid flow from the tank 203 and then along an upstream to downstream direction through the UF unit 201. A chemical feed line 208 in operational communication with the tank 203 is used to feed chemicals to the tank 203 for this cleaning function. For example, sodium hypochlorite may be fed through one chemical feed line so as to help control organic fouling with citric acid or phosphoric acid fed to the tank 203 through a second chemical feed line to help reduce inorganic fouling, if needed. During the daily UF cleaning cycle, the RO unit 202 is usually shut down. In the cleaning cycle, the UF cleaning conduit 207 may also be used to recirculate cleaning fluid from the tank 203 to the UF unit 201.

A UF rinsing conduit 212 is also provided for directing rinsing fluid flow from an upstream to a downstream direction through the UF unit 201 then into the tank 203 in a UF rinsing mode of operation. The tank 203 further includes a drain means 221 for draining rinsing fluid therefrom during the UF rinsing mode of operation. Additionally, the RO unit 202 is normally shut down during this rinsing mode. It is contemplated that in some embodiments, operation conduit 204 can be used as rinsing conduit 212.

In another mode of operation, the RO unit 202 is cleaned. Here, the operation, backwash, cleaning and rinsing conduits are closed. The RO conduit 210 is provided to supply cleaning chemical to the RO unit 202. A recycle conduit 211 extends from the downstream product exit 226 of the RO unit 202 to the tank 203 to recycle the RO cleaning fluid to the tank 203. Additionally, a RO recovery conduit 206 extends from the concentrate exit 213 from the RO and returns the cleaning fluid to the tank 203. In embodiments using an optional RO recovery unit 222, permeate and concentrate from the RO recovery unit 222 are returned to the tank 203 via RO recovery conduit 206. Acid cleaning is usually the first cleaning treatment employed, followed by caustic recirculation through the tank 203, RO unit 202 and optional RO recovery unit 222.

Typically, on a periodic basis, such RO unit 202 is rinsed. Here, source 220 or influent water is pumped through the UF unit 201 to the tank 203 where the UF permeate flows through a RO conduit 210 from the tank 203 by employment of a RO high pressure pump 219 into the RO unit 202. This rinsing fluid is then drained via the RO/RO recovery drain 224 after it has rinsed the RO unit 202.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention. Therefore, the technical scope of the present invention encompasses not only those embodiments described above, but also all that fall within the scope of the appended claims.

This written description uses examples to disclose the invention, including the best mode, and also to enable any person skilled in the art to practice the invention, including making and using any devices or systems and performing any incorporated processes. The patentable scope of the invention is defined by the claims, and may include other examples that occur to those skilled in the art. These other examples are intended to be within the scope of the claims if they have structural elements that do not differ from the literal language of the claims, or if they include equivalent structural elements with insubstantial differences from the literal language of the claims.

What is claimed is:

1. A water purification system comprising:
an UF unit, a RO unit, and a tank; said UF unit is upstream of said tank on an operation conduit, said tank is upstream of said RO unit on an RO conduit;
a backwash conduit between said tank and said UF unit.

2. The water purification system of claim 1 further comprising:
a production mode, wherein said operational conduit conducts UF permeate from said UF unit to said tank, said RO conduit further conducts UF permeate from said tank to said RO unit.

3. The water purification system of claim 2 further comprising:
a RO recovery unit to process concentrate from said RO unit; wherein in said production mode, permeate from said RO recovery unit is conducted to said tank through a RO recovery conduit.

4. The water purification system of claim 2 further comprising,
a UF backwash mode, wherein said backwash conduit conducts fluid from said tank in an upstream direction through said UF unit.

5. The water purification system of claim 4, wherein said tank is sized to allow said RO unit to operate during said UF backwash mode.

6. The water purification system of claim 5 further comprising:
a UF cleaning conduit provided between said tank and said UF unit, and a chemical feed line in operational communication with said tank;
wherein in a maintenance cleaning mode, said UF cleaning conduit directs cleaning fluid from said tank and along said operational conduit in an upstream to downstream direction through said UF unit during a cleaning cycle of said maintenance cleaning mode;
cleaning chemicals are directed into said tank through said chemical feed line.

7. The water purification system of claim 6, wherein said maintenance cleaning mode is a UF daily cleaning mode or a UF monthly recovery clean recirculation and soak mode.

8. The water purification system of claim 6, wherein said cleaning chemicals include at least one of sodium hypochlorite, citric acid, or phosphoric acid.

9. The water purification system of claim 8, wherein the contents of said tank are heated with a heater.

10. The water purification system of claim 6, further comprising:
a recycle conduit, and a UF rinsing conduit;
said UF rinsing conduit is situated between said tank and said UF unit for directing rinsing fluid flow from an upstream to a downstream direction through said UF unit and into said tank during a rinse cycle of said maintenance cleaning mode;
said RO conduit supplies cleaning chemical from said tank to said RO unit; said recycle conduit directs cleaning fluid from a product exit of said RO unit to said tank.

11. The water purification system of claim 10, further comprising:
a RO cleaning mode having a cleaning cycle;
wherein said RO conduit provides cleaning chemical to said RO unit and said recycle conduit directs said cleaning fluid from said product exit of said RO unit into said tank.

12. The water purification system of claim 10, further comprising:
a RO cleaning mode having a rinse cycle;
wherein a booster/CIP pump conducts rinsing fluid from said tank and through said RO unit.

13. The water purification system of claim 10, further comprising:
a RO recovery unit to process the RO unit concentrate;
wherein in said cleaning cycle of said RO cleaning mode, said permeate from said RO recovery unit is conducted to said tank through a RO recovery conduit.

14. A water purification system comprising:
an UF unit, a booster/CIP pump, an RO unit, and a tank;
said UF unit is located at the upstream end of an operation conduit and said tank is located at the downstream end of said operation conduit;
said tank is located at the upstream end of a RO conduit and said RO unit is located at the downstream end of said RO conduit,
said booster/CIP pump is located downstream of said tank and upstream of said RO unit on said RO conduit.

15. The water purification system of claim 14 further comprising:
a backwash/CIP pump,
wherein said backwash/CIP pump is configured to draw water from said tank and direct it upstream through said UF unit using a backwash conduit.

16. The water purification system of claim 15, wherein said tank acts as a break tank for said RO unit and as a source for said backwash/CIP pump and said booster/CIP pump.

17. The water purification system of claim 16, wherein a pre-filter is located upstream of said UF unit on said operation conduit and a UF feed pump is located upstream of said pre-filter on said operation conduit.

18. The water purification system of claim 17, wherein said system can operate in at least one of the following modes: UF/RO production, UF backwash and RO production, UF daily maintenance clean, UF monthly recovery clean, or RO quarterly clean.

19. A method of operating a water purification system comprising:
conducting UF permeate from a tank to a RO unit along an RO conduit, and conducting fluid from said tank in an upstream direction through said UF unit along a backwash conduit in a UF backwash mode;
wherein said tank is sized to allow said RO unit to operate during said UF backwash mode.

20. The method of claim 19, wherein said water purification system further comprises a RO recovery unit to process the RO unit concentrate; said permeate from said RO recovery unit is conducted to said tank through a RO recovery conduit.
